(19) United States
(12) Patent Application Publication
(10) Pub. No.: US 2020/0037414 A1
(43) Pub. Date: Jan. 30, 2020

(54) PLANT LIGHT FOR PROMOTING PLANT GROWTH AND CONTROL SYSTEM THEREOF

(71) Applicant: Jinsheng DENG, Rancho Dominguez, CA (US)

(72) Inventor: Jinsheng DENG, Rancho Dominguez, CA (US)

(73) Assignee: EVERY INDUSTRY LLC

(21) Appl. No.: 16/045,722

(22) Filed: Jul. 25, 2018

(51) Int. Cl. H05B 33/08; F21V 29/60; A01G 7/04

(52) U.S. Cl. CPC H05B 33/0872; F21Y 2115/10; A01G 7/045; F21V 29/60

(57) ABSTRACT

A plant lamp and a control system thereof for promoting plant growth, comprising: a main control module, and a light source module, a temperature control module, a power supply module and a heat dissipation module connected to the main control module; the light source in the light source module is composed of red, blue and white LEDs, and the LEDs of each color system are connected to each other. The three color LEDs of the light source can be individually adjusted or adjusted as a whole. This allows you to simulate different lighting. This can simulate different lighting. A user can provide optimal illumination to the plants by adjusting the intensity of the different color light-emitting circuits according to the needs of the plant growth, thereby further promoting the growth of the plants.

### BACKGROUND OF INVENTION

### 1. Field of the Invention

The invention relates to a field of indoor plant cultivation technology, particularly to a plant light and a control system thereof which can be used for promoting plant growth.

### 2.Description of Related Art

Due to the occurrence of food safety problems in recent years, the demand for convenient indoor plant planting equipment by individuals and families has been very large. In order to make up for the lack of illumination of indoor planting, plant lights have been used instead of sunlight to make plants photosynthesis and promote the growth of plants. The light sources used in traditional plant lamps are: high pressure sodium lamps, metal halide lamps, ceramic metal halide lamps, plasma lamps, fluorescent lamps, and the like. In recent years, with the continuous development of LED technology, plant lights have gradually adopted LED as a light source.

Current plant lights are based on the needs of plant growth, but different plants have different requirements for light, even for the same plant, which requires different spectral light requirements at different growth cycles. However, the current light source of the plant lamp is basically set at the time of production, and the user usually only selects the intensity of the light source, and cannot adjust the light source according to actual needs. In addition, since the light source of the plant lamp is designed according to the illumination required for plant growth, the illumination of the plant lamp has certain damage to the human eye, most of the plant light source systems are manually adjusted, and the strong light of the plant lights is bound to cause damage to the human eye.

Furthermore, current plant lights do not take into account the effects of temperature on plant growth. Plant lights produce a lot of heat, which directly radiates heat from plants and can also cause damage to plants. At the same time, the current plant lamp itself also has a heat dissipation problem. Because the plant lamp needs a long time of work, if the heal generated by the plant lamp cannot be dissipated in time, it not only affects the performance of the LED lamp, but also the high temperature will have a certain adverse effect on plant growth.

### SUMMARY OF THE INVENTION

The technical problem to be solved by the present invention is to overcome the deficiencies of the prior art and to provide a plant light for promoting plant production.

In order to solve the above technical problems, the present invention adopts the following technical solutions:

A plant light for promoting plant growth, comprising:

a housing (1), LEDs (2) arranged in an array on a bottom surface of the housing (1), and heat dissipation holes disposed on another side of the housing;

wherein the LEDs (2) are composed of three sets of LEDs of different color systems, and the LEDs of each color system are connected to each other to form a first lighting circuit, a second lighting circuit and a third lighting circuit connected in parallel with each other;

wherein the first lighting circuit, the second lighting circuit and the third lighting circuit are respectively connected to a LED power input interface through a first dimming circuit, a second dimming circuit and a third dimming circuit; a total dimming circuit is disposed in front of the LED power input interface;

the first lighting circuit, the second lighting circuit and the third lighting circuit are simultaneously dimmed by controlling the total voltage of the LED power input interlace through the total dimming circuit.

More particularly, wherein the LEDs are composed of three colors of red, blue and white LEDs.

More particularly, wherein the housing (1) includes cooling fans disposed correspondingly at the heat dissipation holes.

More particularly, wherein the housing (1) is a double-cavity heat-dissipating structure.

A control system for a plant light for promoting plant growth, the control system comprising:

a main control module, and a light source module, a temperature control module, a power supply module and a heat dissipation module connected to the main control module, wherein:

the power supply module is connected to an external power source and supplies power to the control system;

the main control module receives the dimming command, and sends a signal to the corresponding dimming circuit in the light source module to perform the stepless or step dimming for the corresponding lighting circuit in the light source module;

the temperature control module feeds back the operating temperature of the control system to the main control module through a temperature measuring component, and the main control module responds according to the received temperature signal;

the heat dissipation module has a plurality of cooling fans for dissipating heat from the control system.

More particularly, wherein the light source module is composed of red, blue and white LEDs, and the LEDs of each color are connected to each other to form a first lighting circuit, a second lighting circuit and a third lighting circuit which are connected in parallel with each other.

More particularly, wherein the first lighting circuit performs stepless dimming and step dimming through a first dimming circuit; the second lighting circuit performs stepless dimming and step dimming through a second dimming circuit; the third lighting circuit performs stepless dimming and step dimming through a third dimming circuit.

More particularly, wherein the first, second, and third lighting circuits perform synchronous stepless and step dimming through a total dimming circuit.

More particularly, wherein the control system further includes a wireless control module, the control system receives an external wireless signal through a wireless transmission component in the wireless control module and transmits the wireless signal to the main control module to give an instruction to the main control module; the main control module transmits the system operation parameters to the wireless control module, and a parameter information method is used to dispose the external wireless signal receiving end through the wireless transmission component.

The invention adopts the above technical scheme, which has the following advantages:

1.The light source is composed of three colors of red, blue and white LEDs, and the LEDs of each color system are connected to each other to form a lighting circuit connected in parallel with each other, and the LEDs of the three colors can be separately adjusted or simultaneously adjusted. This will simulate different lighting. The user can provide optimal illumination to the plants by adjusting the intensity of the different color lighting circuits according to the needs of the plant growth, thereby further promoting the growth of the plants.

2.The invention adopts a wireless control module, and the user can use the mobile phone as a wireless signal transmitting end for remote control, thereby avoiding adjusting and setting directly under the illumination of the plant light, thereby reducing the damage of the plant light to the human eye.

3. The invention includes a temperature control module for detecting the working temperature of the plant light in real time through the temperature control module, when the temperature exceeds the preset value, the power can be cut off by the main control module, and then restart after the temperature drops to the set temperature.

4. The double-cavity heat-dissipating structure is adopted in the plant light of the invention, and the plant light housing is formed into two heat-dissipating cavities, which can effectively cut the heat circulation inside the housing to achieve better heat dissipation effect, thereby ensuring the operation of the plant light.

### BRIEF DESCRIPTION OF THE DRAWINGS

FIG. 1 is a perspective view of a plant light of the present invention;

FIG. 2 is an exploded perspective view of the plant light of the present invention;

FIG. 3 is a schematic diagram of a plant light control system of the present invention;

FIG. 4 is a circuit schematic diagram of a light source module of the present invention.

### DETAILED DESCRIPTION OF THE INVENTION

The invention will now be further described with reference to the embodiments and the drawings.

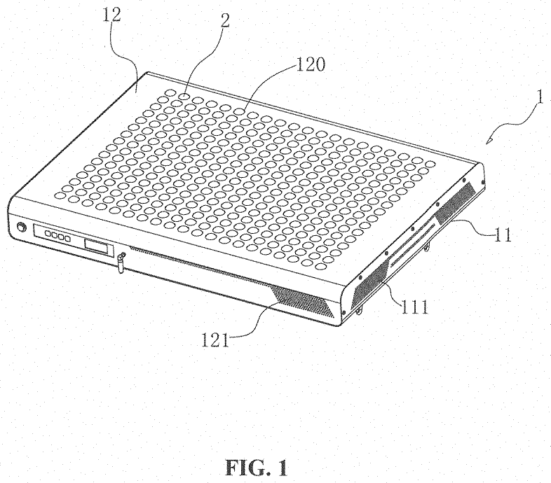

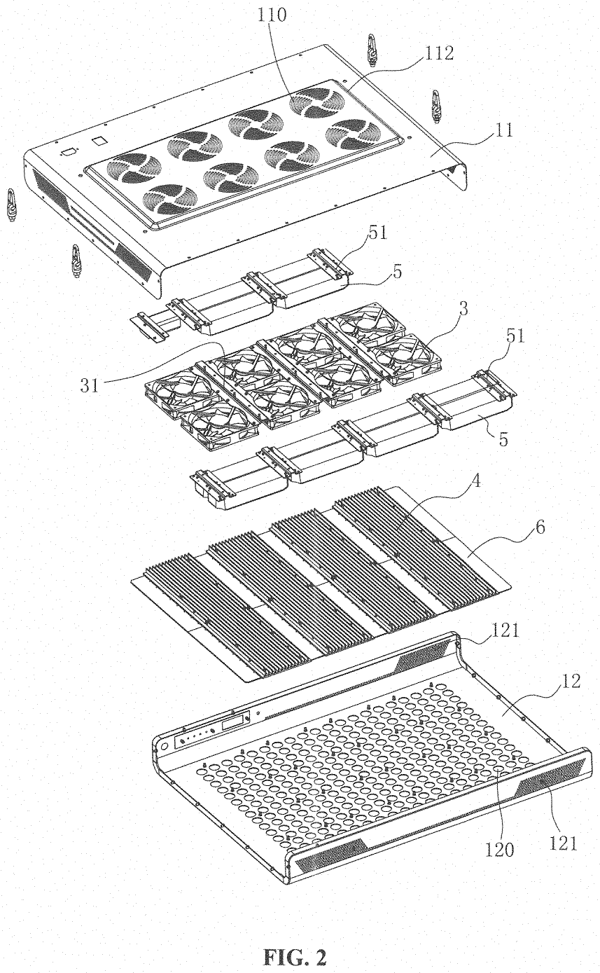

As shown in FIGS. 1 and 2, A plant light of the present invention comprises: a housing 1, LEDs 2, cooling fans 3, heat sinks 4, a driver 5, and a circuit board 6.

The housing 1 is formed by an upper cover 11 and a lower cover 12 being fastened to each other. The upper cover 11 and the lower cover 12 are U-shaped and fixed by screws to form a box structure. The upper cover 11 and the lower cover 12 respectively include heat dissipation holes 111, 112 in side surfaces thereof.

The cooling fans 3 and the driver 5 are fixed to an inner surface of the upper cover 11, and the upper cover 11 includes ventilation holes 110 corresponding to each of the cooling fans 3. In an array of the cooling fans 3, the adjacent two rows of cooling fans 3 are connected by a first connecting bar 31, and the first connecting bar 31 is fixed to the inner surface of the upper cover 11. The area of the upper cover 11 where the cooling fans 3 are disposed outwardly forms a convex portion 112, and the ventilation holes 110 are disposed on the convex portion 112. The driver 5 is fixed to the inner surface of the upper cover 11 by a second connecting bar 51 and located outside the area of the cooling fans 3.

The LEDs 2 which are arranged in an array are fixed on a lower surface of the circuit board 6. The heat sink 4 is fixed on an upper surface of the circuit board 6. The lower cover 12 includes light holes 120 distributed in an array and corresponding to the LEDs 2. The circuit board 6 is fixed to an inner surface of the lower cover 12 by screws, and the heat sink 4 is a fin heat sink.

The invention adopts a double-cavity heat-dissipating structure, that is, a cavity formed by the upper cover 11 and the lower cover 12, which is divided into upper and lower layers, wherein circuit board 6 having the LEDs 2 is fixed on the lower cover 12, the heat generated by the LEDs 2 is directly dissipated through the heat sink 4 fixed on the circuit board 6, and the cooling fan 3 is fixed on the upper cover 11, the cooling fan 3 is directly blown on the heat sink 4, and the heat generated by the heat sink 4 is blown off and discharged through the heat dissipation holes on the sides of the upper and lower covers, so that heat is prevented from circulating inside the cavity, and the heat circulation inside the cavity is effectively cut off. This ensures that the interior of the entire plant light is in a low temperature operating environment.

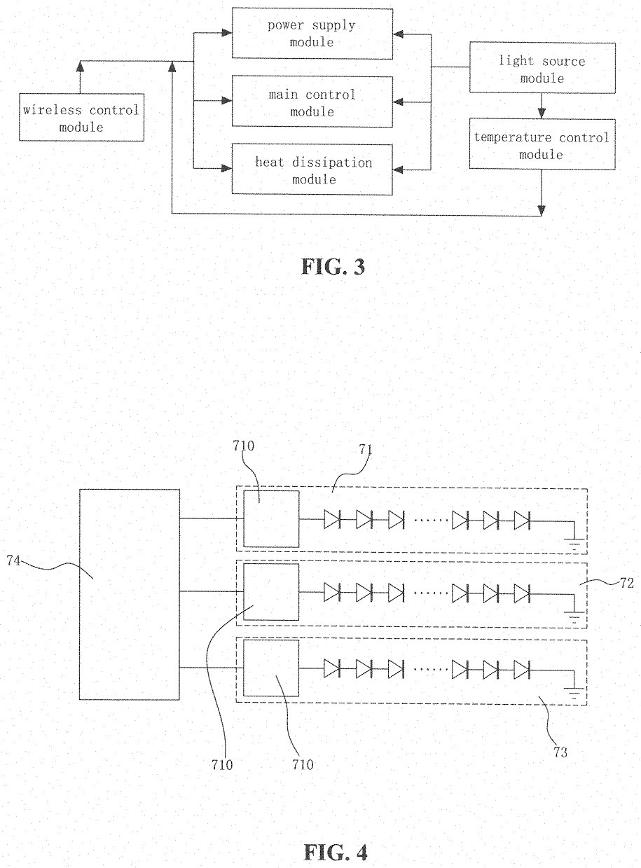

As shown in FIG. 3 and FIG. 4, a control system of the present invention comprises: a main control module, and a light source module, a temperature control module, a power supply module and a heat dissipation module connected to the main control module.

The main control module is formed by the circuit board 6, which serves as a control core of the present invention. The LEDs 2 and the driver 5 form the light source module, and the cooling fans and the heat sink form the heat dissipation module. The power supply module is composed of a power plug and a power conversion circuit disposed on the housing, and the temperature control module is disposed on the circuit board and includes a temperature measuring component.

The power supply module is connected to an external power supply and supplies power to the entire control system; after receiving the dimming command, the main control module sends a signal to a corresponding dimming circuit in the light source module to perform stepless or step dimming for the corresponding lighting circuit in the light source module. The temperature control module feeds back the operating temperature of the system to the main control module by the temperature measuring component, and the main control module responds according to the received temperature signal, for example, when the temperature signal received by the main control module indicates that the temperature exceeds 65° C., the main control module will automatically cut off the power supply to the lighting circuit by the power supply module. When the temperature is cooled to 50°, the system will automatically turn on.

The light source in the light source module of the present invention is composed of red, blue, and white LEDs, and the LEDs of each color system are connected to each other to form a first lighting circuit, a second lighting circuit, and a third lighting circuit that are connected in parallel with each other. At the same time, the LEDs in the red color system further includes a plurality of LEDs of different colors, including: red, dark red, purple, orange red, and the LEDs of different colors together form the first light-emitting circuit of a red color system. The first lighting circuit composed of different colors is for simulating the spectrum of sunlight, wherein purple light is used for plant sterilization, and red light, dark red, and orange red are helpful for plant germination and growth quality.

Light from three different color LEDs provides illumination of a specific spectrum required for plant growth. The effects of different wavelengths of light on plant growth are listed below.
208-315 nm—It has minimal effect on growth morphology and physiological processes.
315-400 nm—chlorophyll absorption is less, affecting the photoperiod effect and preventing stem elongation.
400-520 nm (blue)—the absorption ratio of chlorophyll and carotene is large, which has the greatest impact on photosynthesis.
610-720 nm (red)—The pigment absorption rate is low, which has a significant effect on photosynthesis and cycle effects.
720-1000 nm—It has low absorption rate and stimulates cell elongation, which affects the opening and seed germination.
More than 1000 nm—converted into heat.

As can be seen from the above data, the photosynthesis of plants in different wavelengths is different for plants. The present invention can adjust the LEDs of the three color systems according to the needs of different growth cycles of the plants to provide optimal illumination, thereby promoting plant growth.

In order to achieve separate control of different color LEDs, the first lighting circuit performs stepless dimming and step dimming by the first dimming circuit; the second lighting circuit performs stepless dimming and step dimming through the second dimming circuit; the third lighting circuit performs stepless dimming and step dimming by the third dimming circuit. For example, the brightness values of the three lighting circuits are 0%-100% stepless dimming, or step dimming, when step dimming is used, each lighting circuit is set to four periods of brightness. When the system time is set accurately, the time reaches the timing period, and the entire light will automatically change to the preset brightness and cycle continuously for 24 hours.

At the same time, in order to achieve synchronous adjustment of three color system lighting circuits, the first, second, and third lighting circuits perform synchronous stepless and step dimming of three lighting circuits through a total dimming circuit

As shown in FIG. 3, the control system further includes a wireless control module, and the wireless control module is connected to the main control module; the control system receives an external wireless signal through a wireless transmission component in the wireless control module and transmits the wireless signal to the main control module to give an instruction to the main control module; the main control module transmits the system operation parameters to the wireless control module, and a parameter information method is used to dispose the external wireless signal receiving end through the wireless transmission component. A user can use the mobile phone as the transmitting and receiving end of the wireless signal to operate the control system, and receive the operating parameters from the control system, thereby realizing remote control.

The above only describes some exemplary embodiments of the present invention. Those having ordinary skills in the art may also make many modifications and improvements without departing from the conception of the invention, which shall all fall within the protection scope of the invention.

1. A plant promoting plant growth, comprising:
a housing (1), LEDs (2) arranged in an array on a bottom surface of the housing (1), and heat dissipation holes disposed on another side of the housing;
wherein the LEDs (2) are composed of three sets of LEDs of different color systems, and the LEDs of each color system are connected to each other to form a first lighting circuit, a second lighting circuit and a third lighting circuit connected in parallel with each other;
wherein the first lighting circuit, the second lighting circuit and the third lighting circuit are respectively connected to a LED power input interface through a first dimming circuit, a second dimming circuit and a third dimming circuit; a total dimming circuit is disposed in front of the LED power input interface;
the first lighting circuit, the second lighting circuit and the third lighting circuit are simultaneously dimmed by controlling the total voltage of the LED power input interface through the total dimming circuit.

2. The plant light according to claim 1, wherein the LEDs are composed of three colors of red, blue. and white LEDs.

3. The plant light according to claim 1, wherein the housing (1) includes cooling fans disposed correspondingly at the heat dissipation holes.

4. The plant light according to claim 1, wherein the housing (1) is a double-cavity heat-dissipating structure.

5. A control system for plant light promoting plant growth, the control system comprising:
a main control module, and a light source module, a temperature control module, a power supply module and a heat dissipation module connected to the main control module, wherein:
the power supply module is connected to an external power source and supplies power to the control system;
the main control module receives the dimming command, and sends a signal to the corresponding dimming circuit in the light source module to perform the stepless or step dimming for the corresponding lighting circuit in the light source module;
the temperature control module feeds back the operating temperature of the control system to the main control module through a temperature measuring component, and the main control module responds according to the received temperature signal;
the heat dissipation module has a plurality of cooling fans for dissipating heat from the control system.

6. The control system for a plant light according to claim 5, wherein the fight source module is composed of red, blue and white LEDs, and the LEDs of each color are connected to each other to form a first lighting circuit, a second lighting circuit and third lighting circuit which are connected in parallel with each other.

7. The control system for a plant light according to claim 6, wherein the first lighting circuit performs stepless dimming and step dimming through a first dimming circuit; the second lighting circuit performs stepless dimming and step dimming through a second dimming circuit;
the third lighting circuit performs stepless dimming and step dimming through a third dimming circuit.

8. The control system for a plant light according to claim 6, wherein the first, second, and third lighting circuits perform synchronous stepless and step dimming through a total dimming circuit.

9. The control system for a plant light according to claim 5, wherein the control system further includes a wireless control module, the control system receives an external wireless signal through a wireless transmission component in the wireless control module and transmits the wireless signal to the main control module to give an instruction to the main control module; the main control module transmits the system operation parameters to the wireless control module, and a parameter information method is used to dispose the external wireless signal receiving end through the wireless transmission component.
